(19) United States
(12) Patent Application Publication
(10) Pub. No.: US 2017/0112155 A1
(43) Pub. Date: Apr. 27, 2017

(54) OVEN FOR FOOD USE COMPRISING A SMOKING AND/OR FLAVORING DEVICE

(71) Applicant: UNOX S.p.A., Cadoneghe (PD) (IT)

(72) Inventor: Enrico FRANZOLIN, Cadoneghe (PD) (IT)

(73) Assignee: UNOX S.p.A., Cadoneche (PD) (IT)

(21) Appl. No.: 15/297,724

(22) Filed: Oct. 19, 2016

(30) Foreign Application Priority Data
Oct. 21, 2015 (IT) 202015000063991

(51) Int. Cl. A23B 4/052; A23B 4/056

(52) U.S. Cl. CPC A23B 4/052; A23B 4/056; A23V 2002/00

(57) ABSTRACT

An oven for food use comprising a cooking chamber and a device for smoking and/or flavoring foodstuffs that includes at least one container capable of being placed inside the cooking chamber and able to contain substances suitable for generating smoke for smoking and/or vapors for flavoring as well as a heat source provided for transferring heat to said substances for the purpose of smoking and/or flavoring the foodstuffs, the oven comprising at least one temperature sensor provided for detecting the temperature of the substance in the container.

### FIELD OF THE INVENTION

The present invention relates to an oven for food use, comprising a device for smoking and/or flavoring foodstuffs.

### BACKGROUND

In the specific technical context, it is known to provide devices for smoking and/or flavoring the foodstuffs in ovens for food use, particularly in professional ovens.

Typically, in these types of ovens, the foodstuffs are smoked inside the ovens, mainly at low temperature, according to some known methods. The smoking device is usually produced in the form of a box-shaped container, inside which the appropriate material (preferably wood suitable for the purpose, of an appropriate type and quality) and a heat source required for igniting the material serving to produce the smoke are placed. A typical method involves inserting into the cooking chamber the box-shaped container provided for producing smoke inside said chamber, and using a resistor supplied with power as the heat source.

One of the identifiable limitations of the abovementioned system is the fact that, following activation of the heat source, the substance contained in the smoking and/or flavoring device is subjected to a heating process which can reach undesirable temperatures so as to compromise the process of smoking and/or flavoring the food. For example, when smoking, if wood is selected as the smoking material, there is the risk of triggering burning of the wood as the temperature increases, consequently generating undesirable odors and transferring these, which are inacceptable for a correct smoking process, to the foodstuff.

The flavoring process is similar to the smoking process, the only difference being that the container device is configured for producing flavoring vapors. The methods for flavoring the foodstuffs are, however, exactly the same as those mentioned above with regard to smoking, and have substantially the same limitations and same problems as already mentioned for smoking.

### SUMMARY

The main aim of the invention is to provide an oven for food use, comprising a device for smoking and/or flavoring the foodstuffs, which oven is structurally and functionally designed to remedy the problems of the cited prior art.

This aim and others that will appear clearly below are achieved by an oven for food use, comprising a smoking and/or flavoring device produced according to the attached claims.

### BRIEF DESCRIPTION OF THE DRAWINGS

Other features and advantages of the invention will be more clearly apparent from the following detailed description of a preferred embodiment thereof, illustrated by way of non-restrictive example with reference to the attached drawings, in which:

FIG. 1 is a diagrammatic, partially sectional plan view of an oven according to the invention,

FIGS. 2 and 3 are partial, enlarged perspective views of a detail of the oven in FIG. 1, shown in two different configurations,

FIGS. 4 and 5 are perspective views of another detail shown in FIGS. 2 and 3.

### DETAILED DESCRIPTION OF THE PREFERRED EMBODIMENTS

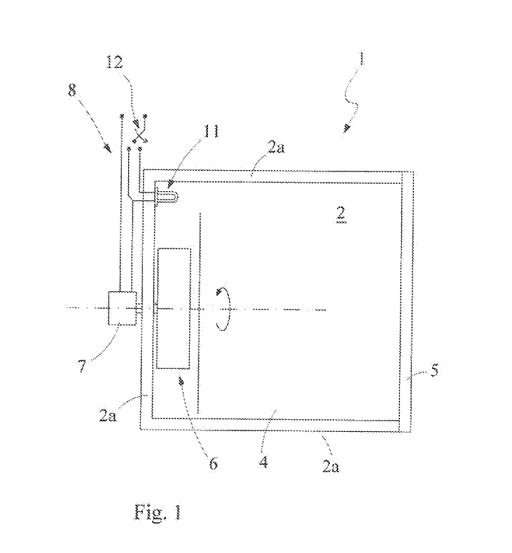

With reference initially to FIG. 1, reference numeral 1 indicates overall, and only diagrammatically, an oven for food use produced according to the invention.

The oven 1 is provided with a cooking chamber 2, inside which the foodstuffs to be cooked are accommodated. Said chamber is delimited by side walls 2a and a top wall 3 opposite a bottom surface 4. Reference numeral 5 indicates a door for access to the cooking chamber for introducing and removing the foodstuffs being cooked.

The oven is also provided with heat-generating means, not illustrated, for example including a plurality of electrical resistors, with which the temperature inside the chamber 2 is regulated in the preselected cooking cycle. To regulate temperature changes, a fan 6 is also provided that is rotated by an electric motor 7, which motor is arranged inside the cooking chamber that has the function of producing forced air circulation, suitable for ensuring the predetermined cooking process.

The motor 7 is supplied with power by an electrical circuit that is illustrated only partially and diagrammatically and is indicated by reference numeral 8 in FIG. 1.

The oven 1 is furthermore provided with a device 9 for smoking and/or flavoring the foodstuffs, of the type comprising a box-shaped container 10, which container is provided so as to accommodate therein the substance or appropriate material for producing smoke for smoking and/or vapors for flavoring, following suitable heating. In the case of a smoking device, provision is made to insert into the container 10 wood, for example as chips, or other suitable material capable of being ignited by a heat source. On the other hand, in the case of a flavoring device, provision is made to insert into the container 10, for example, a liquid substance suitable for producing aromatic vapors when suitably heated.

In accordance with the invention, the heat source connected to the device 9 is produced by a resistance element including an electrical resistor 11 provided inside the cooking chamber.

The resistor 11 is preferably designed to be part of the drive circuit 8 for the motor 7 and is selectively connected to or disconnected from the circuit in order to vary the speed of the fan after power is supplied to the resistor or otherwise. The resistor 11 is connected in series to the motor and can be supplied with electric power by switching a switch means 12 (so as to supply electric power to the resistor 11 in series with the motor 7). Connecting the resistor 11 involves reducing the number of rotations of the motor 7 and consequently reducing the speed of the fan, with a correspondingly equal reduction in the air circulation inside the cooking chamber.

The heat generated by the resistor 11 is then advantageously used as a heat source for igniting and/or heating the substance present in the smoking and/or flavoring device 9.

The resistor 11 is also configured and oriented to act as a means for supporting the container 10, so as to removably support the container in an upper zone of the cooking chamber, as described in greater detail below.

The resistor 11 is preferably U-shaped (obtained, for example, by bending a rod-shaped body having a circular section) and is placed close to the top wall 3 of the cooking chamber, protruding into the inside the chamber in a direction substantially parallel to the bottom surface 4. The resistor 11 is capable of being accommodated, by means of a sliding coupling, in a seat 13 of the container, which seat is provided near to a bottom surface 13c thereof and is also open on a side wall 13a of the container. Inside the container 10, the seat 13 is delimited by a profile 13d that has an “omega”-shaped section, and is fixed to the bottom surface 13c. Said profile 13d, as well as supporting the container when the seat 13 is engaged with the resistor 11, has the function of heat exchange, simultaneously keeping the resistor away from the smoking/flavoring substance. Alternatively, however, it is possible not to separate the resistor from the substance present in the container using the “omega”-shaped profile, opting in this case for direct heat exchange.

On the opposite side wall 13b, a gripping member 14 is provided, for example in the form of a handle, which is suitable for allowing the handling and movement of the container 10.

Reference number 15 indicates a covering element for the container that is articulated thereto, for example to the wall opposite the wall provided with a handle, said covering element being provided with one or more cut-outs 16 (shaped, for example, as holes or slots) capable of allowing the release of the smoking smoke and/or the flavoring vapor. The openings 16 can also be provided in the body of the container and not only in the cover.

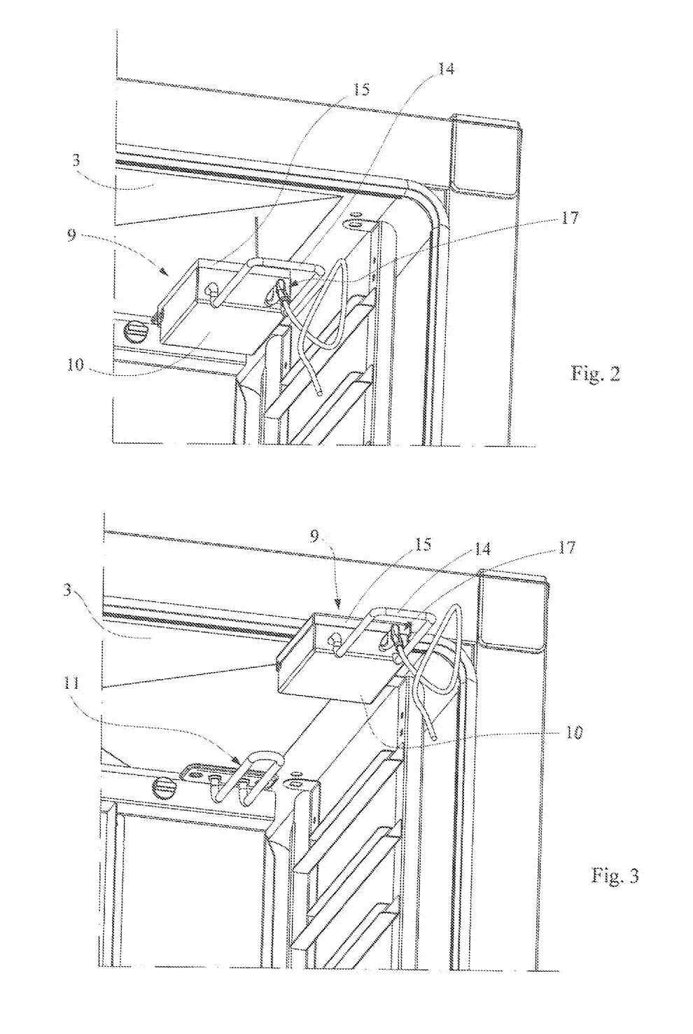

In FIGS. 2 and 3, the container 10 is illustrated in the condition where it is supported by the resistor and in the condition where it is disengaged from said resistor, respectively.

According to a main characteristic of the invention, provision is made to connect the container 10 to a temperature sensor which is indicated overall by the reference numeral 17 and is provided for detecting the temperature of the substance present in the container 10 for smoking and/or flavoring. The sensor is provided with a sensitive element placed inside the container 10 and can be in contact with the substance contained therein or can be inserted fully into a housing well.

Provision is further made to connect the sensor to the control unit (which processes its signal) of the motor 7 (not shown), in such a way that, using a suitable circuit system of said unit, the motor 7 with the resistor 11 in series can be activated or deactivated according to the temperature detected by the sensor 17, so as to keep this temperature at, for example, a preselected threshold value. In the case of smoking, exceeding this threshold may be attributed to the limiting condition in which a combustion process takes place in the woody material, thereby generating smoke and odors that are undesirable for the purposes of the food smoking process.

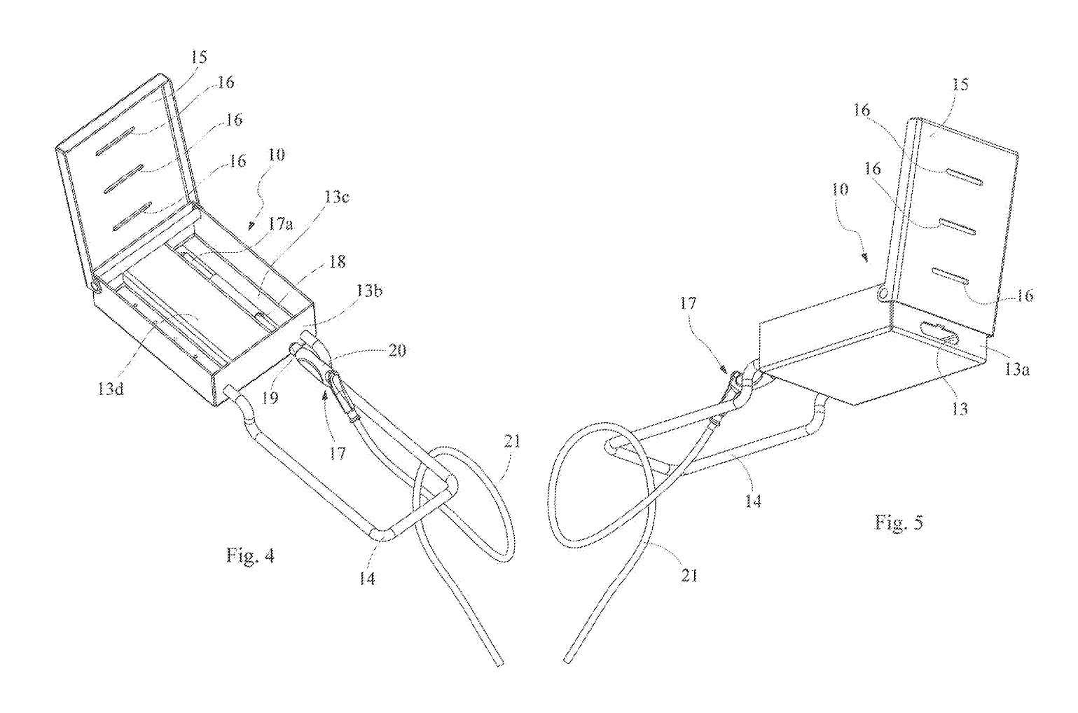

A preferred embodiment of the invention also provides for the food core temperature probe to be selected as the temperature sensor, typically provided inside the cooking chamber and designed to detect the core temperature of the foodstuff during the cooking process. FIGS. 4 and 5 illustrate a preferred example of said probe, which is provided with a sensitive element 17a in the form of a cylindrical point, which is capable of being housed in a tubular seat 18 of a housing well provided inside the container.

The sensor of the core probe can be single-point or multi-point; obviously in the second case a choice must be made to use only one detecting point or to use more than one and take the mean of these, for example, or the highest value.

A hole 19 is provided in the wall 13b of the container for inserting the probe inside the container 10. Reference numeral 20 indicates the body of the probe, which supports the temperature-sensitive element 17a, the cable 21 which connects the probe to the control unit of the oven in order to transfer the signal detected by the sensor extending from said body.

Using the food core temperature probe as the temperature sensor in the smoking and/or flavoring operations has the advantage that the temperature of the substance present in the container 10 can be detected and, above all, controlled, without requiring any additional means or structure in the oven, since the core temperature probe is used for the purpose, being typically arranged in the oven for controlling the core temperature of the foodstuff being cooked.

It should also be noted that the sensor 17 can alternatively be provided independently of the food core temperature probe, if particular conditions or requirements require this. In that case, the oven will be produced so as to comprise the structural and circuit portion suitable for ensuring the functionality of the temperature sensor as described above.

The invention thus achieves the aims proposed, obtaining numerous advantages over the known solutions.

A main advantage lies in the fact that, on account of the provision of a temperature sensor connected to the substance of the smoking and/or flavoring device, it is possible to control and regulate the temperature that said substances reach, allowing said temperature to be maintained below preselected threshold values that are suitable for ensuring that the smoking and/or flavoring process is/are carried out correctly.

Another advantage is that, thanks to the use of the food core temperature probe as the temperature sensor in order to control the smoking and/or flavoring process, the solution as conceived proves structurally simple and low-cost, while guaranteeing adequate regulation of said process.

Yet another advantage is that the oven according to the invention provides for the smoking/flavoring device to be connected to a heat source identified in the resistance element of the motor drive circuit, making it possible on the one hand to recover the heat generated by the resistor, without the need to expend any additional power, and on the other hand not requiring any additional structure inside the oven for the heat source to be connected to the smoking and/or flavoring device.

1. An oven for food use, comprising a cooking chamber and a device for at least one of smoking or flavoring foodstuffs, the device comprising at least one container capable of being placed inside the cooking chamber and able to contain substances suitable for generating at least one of smoke for smoking or vapors for flavoring; and a heat source provided for transferring heat to said substances to at least one of smoke or flavor the foodstuffs, the oven further comprises at least one temperature sensor provided for detecting the temperature of the substance in said container.

2. The oven according to claim 1, comprising a core temperature probe for detecting the core temperature of the foodstuffs during cooking, said probe being a sensor that senses the temperature of the substance present in the container during at least one of the smoking or flavoring process.

3. The oven according to claim 1, further comprising a device which activates or deactivates said heat source depending on the temperature detected by said sensor so as to at least one of regulate the temperature of said substance or to keep the temperature at a predetermined threshold value.

4. The oven according to claim 1, wherein said sensor comprises a sensitive portion for detecting the temperature, said portion is configured to be accommodated inside said container, through a cut-out in the container.

5. The oven according to claim 4, wherein a seat is provided for housing the sensitive portion of the sensor and is arranged, at least in part, inside the container that is configured to accommodate the sensitive portion of the sensor.

6. The oven according to claim 5, wherein said seat for housing the sensor has a tubular shape.

7. The oven according to claim 1, wherein said heat source comprises at least one electrical resistance element provided inside the cooking chamber.

8. The oven according to claim 7, wherein said resistance element is configured to act as a support for supporting said container.

9. The oven according to claim 7, wherein said container is removably supported on said resistance element.

10. The oven according to claim 7, wherein said container is provided with a seat arranged so as to be engaged, in a sliding coupling, with said resistance element.

11. The oven according to claim 10, wherein said container has a box-shaped configuration and said seat is provided proximate to a bottom surface of said box-shaped container.

12. The oven according to claim 1, wherein said container is provided with a covering element articulated to the container, said covering element being provided with at least one cut-out for release of at least one of the smoking smoke or the flavoring vapor.

13. The oven according to claim 1, wherein said container is provided with a gripping member for handling and moving said container.

14. The oven according to claim 7, further comprising at least one variable-speed electric fan, the rotation of which is controlled by an electric motor, and wherein said at least one electrical resistance element is part of an electrical circuit supplying the motor of said electric fan and is provided to be selectively connected to or disconnected from said electrical circuit in order to vary the speed of the fan after electric power is supplied to said resistance element.

15. The oven according to claim 14, wherein said at least one resistance element comprises a resistor connected in series to the motor and is capable of being selectively connected to or disconnected from said circuit, such that the heat generated by said resistor is transferred to the substance contained in said container so as to support at least one of the smoking or flavoring of the foodstuffs placed in the cooking chamber.
